(19) United States
(12) Patent Application Publication
(10) Pub. No.: US 2017/0144898 A1
(43) Pub. Date: May 25, 2017

(54) Device for the Photochemical Treatment of Polluted Water

(71) Applicant: SICO TECHNOLOGY GMBH, Bad Bleiberg (AT)

(72) Inventors: Siegfried EGNER, Adelsheim (DE); Bentsian ELKIN, Filderstadt (DE); Jorge Toro SANTAMARIA, Stuttgart (DE)

(21) Appl. No.: 15/306,298

(22) PCT Filed: Apr. 24, 2015
(86) PCT No.: PCT/EP2015/058959

§ 371 Date: Jan. 5, 2017

(30) Foreign Application Priority Data
Apr. 24, 2014 (DE) 10 2014 207 688.9

(51) Int. Cl. C02F 1/32

(52) U.S. Cl. CPC C02F 1/325; C02F 2201/3228; C02F 2201/328; C02F 2303/04

(57) ABSTRACT

The invention relates to a device (10) for the photochemical treatment or purification of polluted water. Said device (10) comprises at least one flow channel (16) for guiding the polluted water, which is defined at least in sections by a UV-light output face (14) of at least one of the UV-light-generating bodies (12). The at least one flow channel (16) can comprise swirling elements (22; 24; 26; 28; 30) for the polluted water.

The present invention relates to a device for the photochemical treatment of polluted water according to the general concept of claim 1.

### PRIOR ART

The generation of UV light (wavelength of approximately 100 to 400 nm) by exciting gases or gas mixtures with high-frequency electromagnetic waves, particularly with microwaves, is, for example, known from DE 10 2006 022 970 B3. The device generates extensive radiation of UV light.

An excimer radiator is known from EP 0 458 140 A1 that emits electromagnetic radiation within the UV-wavelength range.

A lamp known from DE 10 2009 025 667 A1 functions similarly to a fluorescent tube filled with gas. By appropriately exciting molecules of this gas (with, for example, energy-rich electrons), one or more electrons of the molecules located in the gas are boosted to a more energy-rich electron orbit. Once these electrons return to the original electron orbit, they release energy that is emitted in the form of light-in particular, UV light.

These discharge lamps have been known for a long time and have been proven in practice. One particular advantage of such ionization radiators with a gas that contains, for example, mercury or compounds thereof, is that a majority of the emitted light has a wavelength of approximately 254 nm, e.g., in the case of mercury, and this light can be effectively generated with favorable efficiency.

A conducting unit consisting of quartz glass is known from DE 10 2007 040 466 A1that is provided in sections with a reflective layer consisting of aluminum. Furthermore, light guide elements are provided that improve the coupling of UV light into the interior of the conducting unit.

A device for treating liquids is known from DE 695 09 393 T2, in which the several filter elements are connected in series. Backflushing the filter elements and irradiating the liquid ensures that all of the microorganisms within the liquid are killed.

A cylindrical cuvette device for treating blood or other liquids, inside of which turbulence-generating devices are present, is known from DE 10 2013 204 297. The light sources are arranged outside of the cuvette.

A device for decomposing pollutants with the assistance of a photocatalyst is known from DE 101 18 165 A1.

Furthermore, it is known from EP 0 458 140 that noble gases such as xenon, rather than mercury, may be used in the discharge lamps. Xenon emits UV light at wavelengths of approximately 172 nm, which is more energy-rich than the light emitted by mercury. The wavelength of this UV light accordingly lies within the VUV range. The xenon UV light is, for example, used to roughen surfaces in industrial manufacturing. It is further known that energy-rich xenon UV light can be used to purify wastewater. The xenon UV light splits off a hydroxyl radical OH from H₂O. This species is highly reactive and can therefore be used for the oxidative decomposition of pollutants in water, or also to kill bacteria in polluted wastewater. This effect is known.

A disadvantage of xenon UV light is its shallow penetration depth in water; it amounts to only approximately 5 to 150 μm.

The object of the invention is to create a device for the photochemical purification/treatment of polluted water that is simply designed and uses energy-rich xenon UV light for disinfection.

The object is achieved according to the invention in that the at least one flow channel has a thickness of less than 1 cm and/or possesses swirling elements for the polluted water.

While the water is flowing in a thin flow channel, a substantially laminar flow or a stationary speed distribution arises after a short flow path. Due to the laminar flow in the flow channel and the shallow penetration depth of the xenon UV light in the water, as much as possible of the water flowing in the flow channel flows past a UV-light output face of the UV-light-generating body while the water is flowing through the flow channel, to ensure effective purification/treatment of the polluted water. The flowing water must accordingly form a thin film or be swirled or rearranged. The swirling elements serve this purpose. When the polluted water passes by the swirling elements, a flow is produced in which the water is rearranged such that numerous volume elements of the water on a relatively short flow path spend a sufficiently long time within the area of exposure to the xenon light or the short-lived hydroxyl radicals which are formed by the xenon light in water, and the pollutants contained in the water are thereby decomposed.

The swirling elements can comprise grids, nets, wires, and/or fabric. A laminar flow or a stationary speed distribution arises after a certain flow path of the flowing water, depending upon the thickness of the flow channel. In a flow channel with a thickness of, for example, 1 mm, this occurs after about 2 cm. This means that a new swirling element should again be arranged in the flow channel from this distance at the latest, to ensure the effectiveness of the device in disinfecting the polluted water.

This effect can be alternatively or additionally produced or reinforced when the flow channel possesses, for example, a herringbone geometry, elevations and/or recesses, steps and/or transverse grooves on the inside. These geometries can, of course, also be applied on the light-emitting surface. All of these measures are realized with little effort.

The mixing elements function as a flow guide or static mixer. A chaotic mixture can be achieved. Swirling elements that have a fabric structure are preferably arranged diagonal to the direction of flow, to achieve the chaotic mixture.

Before a laminar flow or a stationary speed distribution again arises in the flow channel, it is also possible to collect the water in a reservoir or a pipe to which is then connected another flow channel section with UV-light-generating lamps.

This causes an intensive mixing of the polluted water and significantly increases the probability that the polluted water passes in immediate proximity to a UV-light output face of a body generating UV light. This means that the purified water in the flow channels sequentially flows by several UV-light output faces of UV-light generating bodies arranged in the device.

It is also possible for the polluted water to flow transversely or laterally over the UV-light-generating bodies so that the respective reaction path is interrupted by as many mixing zones as possible on an edge of the UV-light-generating body. Turbulent flows also produce a favorable mixing, but require more energy to convey the water.

An advantage of the device according to the invention is that the water to be purified does not require any additives such as oxygen and/or ozone, which reduces the cost of disinfection and increases process reliability.

In the device according to the invention, xenon, preferably, is excited for UV generation, wherein the UV light is then generated at a wavelength of approximately 172 nm. In principle, other noble gases such as helium, argon, krypton, or neon can be used. Compounds of several noble gases, and/or compounds with corresponding halogens such as fluorine, chlorine, bromine, or iodine are also possible. It is important to generate light at a wavelength below 185 nm, because this light is very energy-rich.

In a preferred embodiment, the flow channel comprises a rectangular cross-section. In such an embodiment, a UV-light output face of a lamp with an even light output face can easily form a part of the wall of the flow channel. Of course, the UV-light output faces of several of UV-light-generating lamps can also form the flow channel, in that several UV-light-generating bodies are either arranged sequentially, or several of UV-light-generating bodies are arranged parallel to and opposite each other and delimit at least part of the flow channel. This causes the polluted water to pass in immediate proximity to the light-emitting surfaces of the UV-light-generating body more frequently.

With a flow channel designed to be rectangular, a thickness of about 1 mm is preferred. The width of the flow channel is discretionary and can be adapted to the size of the UV-light output face of the UV-light-generating body. The thickness of the flow channel is, in principal, discretionary, but is preferably limited, so that as many parts of the polluted water as possible can be reached by the UV light. A thickness narrower than 1 mm at a desired throughput produces very high pressure, due to the friction, on the interior walls of the flow channel, which also increases the required energy for circulating the polluted water. The thickness of 1 mm represents a good compromise.

Of course, the flow channel can, in principle, comprise any cross-section, such as annular or wavy (corrugated cardboard geometry), wherein the UV-light-generating body is then adapted to correspond to the cross-section, to bring about a direct contact of the polluted water with the UV-light output face of the UV-light-generating body.

Furthermore, a polluted water feed can be arranged in the middle of the flow channel, wherein the polluted water can then flow in two opposing directions. This doubles the throughput of polluted water in the device according to the invention.

Furthermore, the polluted water can flow in several flow channels arranged parallel to each other, wherein each flow channel is assigned a UV-light output face of the least one UV-light-generating body. Such a device significantly increases the throughput of polluted water.

In a further development of the device according to the invention, it is provided that the at least one UV-light-generating body be designed such that the water flowing by replaces at least one electrode for generating the UV radiation, in that the water flowing by is electrically contacted.

Additionally, in this context, when water is used as an electrode, it is provided that a corresponding counter-electrode be coated with a reflective and conductive material.

Furthermore, an inner side of the UV-light-generating lamp can be coated in sections with a material that reflects the UV light. This ensures that the UV light which reaches these sections is not absorbed, but, rather, is reflected and can serve to purify the water. The efficiency of the device according to the invention is thereby easily improved.

Furthermore, the UV-light-generating body is designed to be flat, cubical, round, oval ring-shaped or ring-segment-shaped. The UV-light-generating body is preferably designed such that its UV-light output face defines the flow channel and forms at least one region of a wall of the flow channel. The polluted water can thus flow directly by the UV-light output face.

Furthermore, it is provided that the UV-light-generating body have reinforcing supports in the interior. This serves to increase the stability of the UV-light-generating body, wherein it should be noted that high pressure of the water to be purified can arise within the adjacent flow channel, and low pressure can predominate within the interior of the lamp.

Exemplary embodiments of the invention are shown in the figures and will be explained in greater detail in the following description. Illustrated, in schematic form, are:

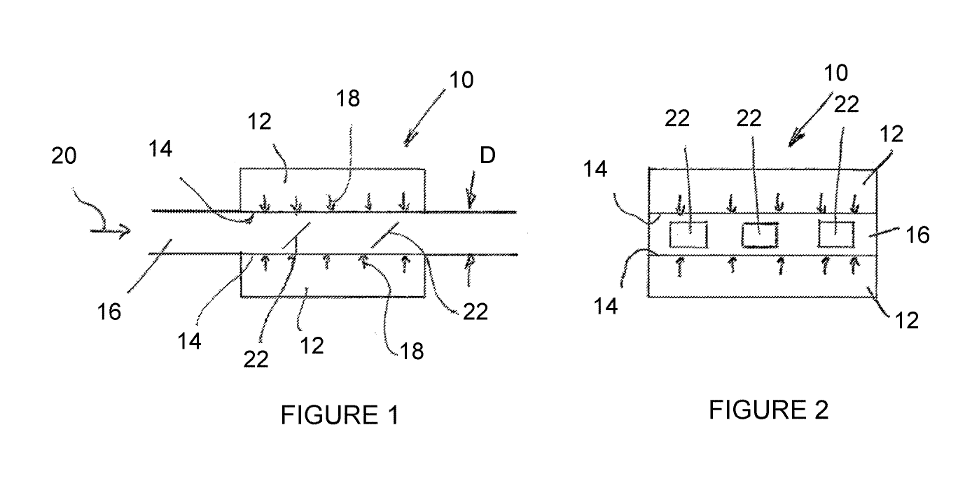

FIG. 1 a side view of a first embodiment of a device according to the invention for treating polluted water;

FIG. 2 the device from FIG. 1 in a side view rotated 90°;

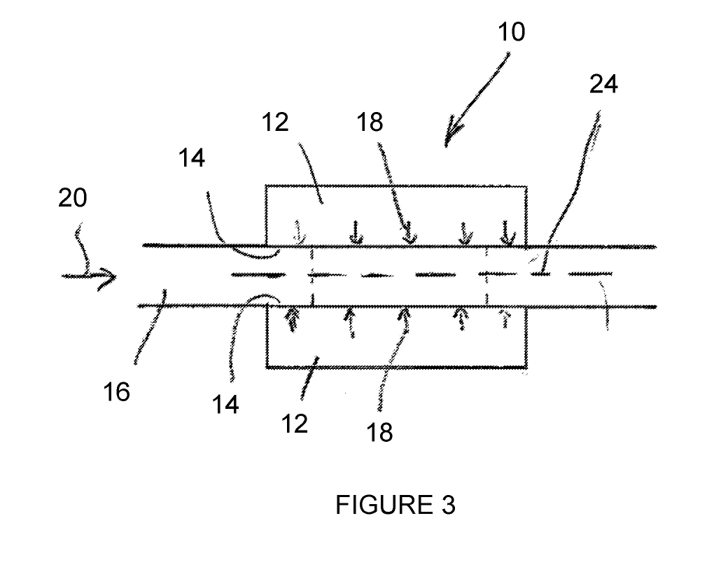

FIG. 3 a side view of a second embodiment of the device according to the invention;

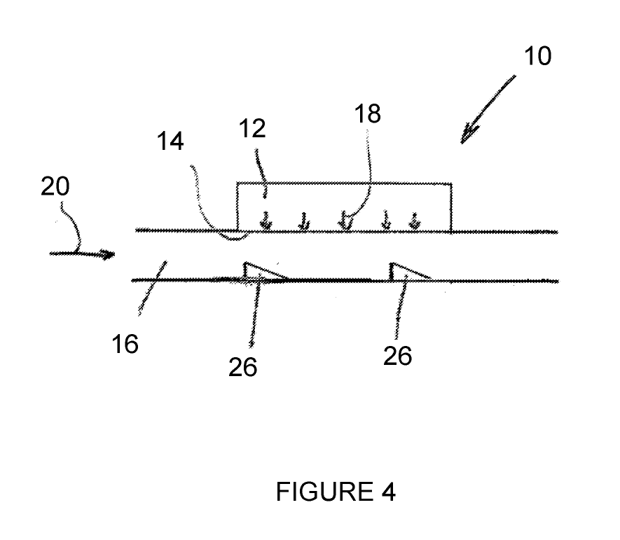

FIG. 4 a side view of a third embodiment of the device according to the invention;

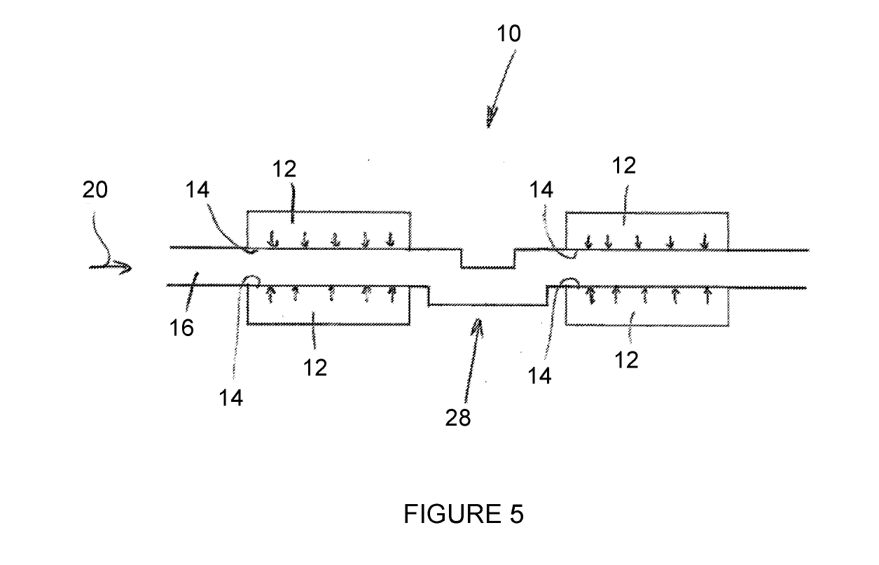

FIG. 5 a side view of a fourth embodiment of the device according to the invention;

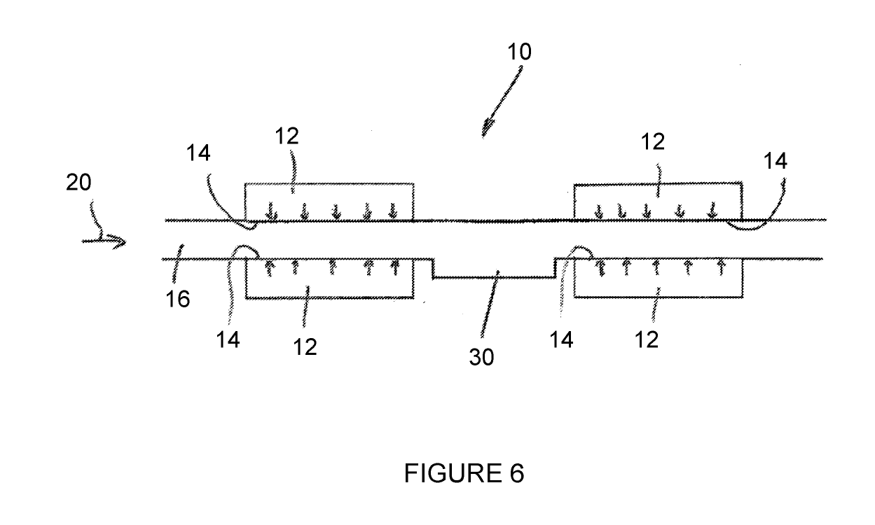

FIG. 6 a side view of a fifth embodiment of the device according to the invention; and

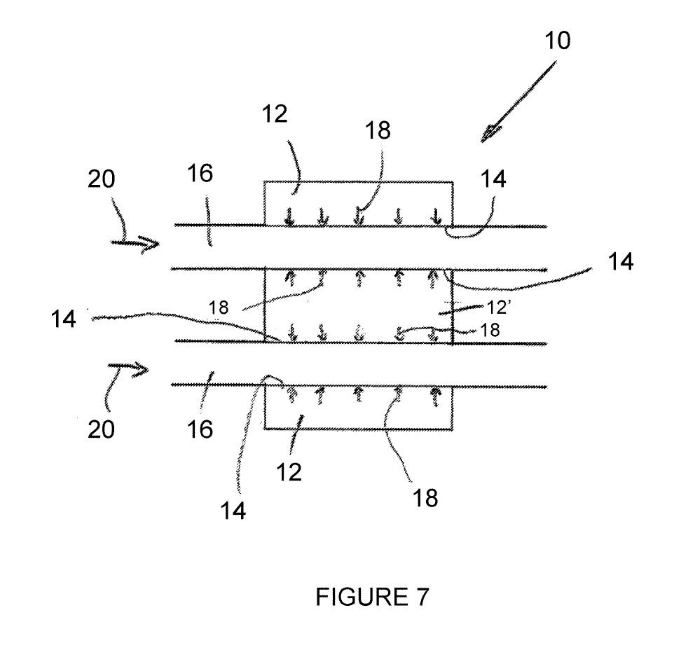

FIG. 7 a side view of a sixth embodiment of the device according to the invention.

FIG. 1 portrays a side view of a first embodiment of a device 10 according to the invention for disinfecting polluted water. FIG. 2 portrays the same device 10 in a side view rotated 90°;

The device 10 from FIG. 1 comprises two UV-light-generating bodies or lamps 12 that, with their UV-light output face 14, form a region of a flow channel 16 for polluted water. Of course, more than two UV-light-generating bodies 12 can, with their light output faces 14, form regions of the flow channel 16. A light exit direction of the UV light from the light output face 14 is indicated by arrows 18. An arrow 20 indicates the direction of flow of the polluted water.

The UV-light-generating body 12 can be designed to be flat, cubical, round, oval ring-shaped or ring-segment-shaped; preferably, the UV-light-generating body 12 is designed as a flat cuboid. It is important that its UV-light output face 14 defines the flow channel 16 and directly forms at least one region of the wall of the flow channel 16. The polluted water can thus flow directly by the UV-light output face 14.

The UV-light-generating body 12 can have reinforcing supports (not shown) in the interior. This serves to increase stability of the UV-light-generating body 12.

The UV-light-generating body 12 comprises xenon as the filling gas and functions according to the known principle of gas discharge, wherein UV light with a wavelength of approximately 172 nm is generated by exciting the xenon gas with high-frequency electromagnetic waves.

As is known, shortwave UV light has a purifying effect, which is exploited in the device 10. However, a penetration depth in water of the UV light generated by the xenon gas is approximately 5 to 150 μm. This means the polluted water flowing through the flow channel 16 and past the light output faces 14 must in large measure be rearranged or swirled, so that the entire water volume comes near the light output faces 14, i.e., within the penetration range of the UV light, at least once while flowing through the device 10. In this exemplary embodiment, the thickness D of the channel 16 is considered to be the spacing between the opposing light output faces 14.

As can be seen in FIG. 2, the flow channel 16 is designed to be rectangular. It could, however, also have an arbitrarily different cross-section, wherein the shape of the lamp 12 must be section-wise adapted to the cross-section, to prevent energy loss from useless recirculation of polluted water. It is important that the light output face 14 form a region of the flow channel 16.

In all the figures, the depictions are not true-to-scale, for the sake of clarity. A preferred thickness D of the flow channel 16 is 1 mm; the width is basically discretionary. 10 cm has proven to be the upper limit of the thickness D of the flow channel 16. Better purification results from thicknesses less than 5 cm, and preferably less than 1 cm.

Upon entering the device 10, the polluted water generally has a turbulent flow and then becomes laminar within the thin channel 16, which is undesirable. In the first embodiment, guide elements 22 are arranged at an angle in the flow channel 16 that rearrange the laminar flow so as to swirl the polluted water. This makes it possible for at least a greater part of the water volume to flow by the light output face 14 of one of the two UV-light-generating bodies 12. During this time, the xenon light forms short-lived hydroxyl radicals in the water that have a purifying effect.

After the water is swirled in the flow channel 16, a laminar flow is automatically re-established after a certain length. The length depends upon the shape of the cross-section of the flow channel 16. With the flow channel 16 of 1 mm thickness formed in the shape of a gap, this occurs after about 2 cm. Consequently, after this length in the flow channel 16, another guide element 22 is arranged, which functions like the first one.

In a further development of the device 10 according to the invention, it is provided that the at least one UV-light-generating body 12 be designed such that the water flowing by replace at least one electrode for generating the UV radiation 18, in that the water flowing by can be electrically contacted. In the course of this, a corresponding counter-electrode can be coated with a reflective and conductive material. Furthermore, an inner side of the UV-light-generating body 12 can be coated in sections with a reflective and conductive material.

FIG. 3 shows a second embodiment of the device 10. In this second embodiment, a grid 24 is arranged parallel to the light output faces 14 as a swirling element in the flow channel 16. The grid 24 can be a wire grid consisting of thin stainless steel wires. The second embodiment is otherwise designed like the first embodiment and functions in the same manner.

FIG. 4 shows a third embodiment of the device 10. The third embodiment comprises only a single UV-light-generating body 12. Wedge-shaped elevations 26 in the flow channel 16 are arranged on the opposite side as swirling elements. The wedge-shaped elevations 26 can also be formed in the light output face 14. The third embodiment is otherwise designed like the first embodiment and functions in a similar manner.

The swirling elements in the region of the UV-light-generating bodies 12 can also be designed as nets, spirals, or fabric. In addition, the flow channel 16 can on its inner side have a herringbone geometry, elevation and recesses of every sort, steps, and/or transverse grooves.

FIG. 5 shows a fourth embodiment of the device 10 in which two sequentially-arranged regions of the flow channel 16 are provided with UV-light-generating bodies 12. More than two such regions could also form parts of the flow channel 16. Any swirling elements can be arranged in the region of the UV-light-generating bodies 12.

If more than one region is provided with UV-light-generating bodies 12, it is possible for a polluted water feed to be arranged in the middle, slightly eccentrically, or at least not at the edge of the flow channel 16, wherein the polluted water subsequently flows in two opposing directions (not shown).

In a connecting region between the two regions with the UV-light-generating bodies 12, the flow channel 16 has a step 28 that functions as a swirling element, since it swirls the laminar flow, or even generates a turbulent speed distribution. The mixing zone formed by the step 28 is indicated by hatching 32. The step 28 does not change the cross-section of the flow channel 16. The fourth embodiment is otherwise designed like the first embodiment and functions in a similar manner.

FIG. 6 shows a fifth embodiment of the device 10. The fifth embodiment is designed similarly to the fourth embodiment. However, here, the course of the cross-section of the flow channel 16 is changed. Between the two regions with the UV-light-generating bodies 12, the flow channel 16 has a reservoir 30 for the water flowing through the device 10. This causes an intensive mixing of the polluted water and significantly increases the probability of polluted water more frequently passing in immediate proximity to the UV-light-generating body 12. The mixing zone formed by the reservoir 30 is indicated by hatching 32. The fifth embodiment reinforces the effect of the fourth embodiment.

FIG. 7 shows a sixth embodiment of the device 10. In the sixth embodiment, the device 10 has flow channels 16 that run parallel to each other. In contrast to the aforementioned embodiments, the device 10 has a UV-light-generating body 12′ that emits UV light 18 in two opposite directions. That is, the UV-light-generating body 12 has UV-light output faces 14 on two sides that form a region of the flow channel 16. The two depicted flow channels 16 can be connected to each other outside of the device 10 so that, for example, a meandering course of the flow channel 16 can be formed. In this case, the two regions with the UV-light-generating bodies 12 can be arranged sequentially in the flow channel 16.

It is, however, also possible for separate, fully independent flow channels 16 to run through the device 10. This causes an increase in the throughput in the device 10.

The research efforts that produced these results were funded by the European Union.

1. Device (10) for the photochemical treatment or purification of water, wherein the device (10) comprises at least one flow channel (16) for guiding the polluted water that is defined at least in sections by a UV-light output face (14) of at least one UV-light-generating body (12), characterized in that the at least one UV-light-generating body (12) generates UV light at a wavelength less than 185 nm, and that the at least one flow channel (16) has a thickness (D) of less than 1 cm and possesses swirling elements (22; 24: 26; 28; 30) for the polluted water.

2. Device (10) according to claim 1, characterized in that the swirling elements comprise grids (24), nets, spirals, guide elements (22), and/or fabric.

3. Device (10) according to claim 1, characterized in that the channel (16) has a herringbone geometry, elevations (26) and recesses, steps (28), and/or transverse grooves.

4. Device (10) according to claim 1, characterized in that the flow channel (16) has a rectangular cross-section.

5. Device (10) according to claim 1, characterized in that a polluted water feed is arranged in the middle of the flow channel (16), wherein the polluted water can then flow in two opposing directions.

6. Device (10) according to claim 1, characterized in that the pollutes wafer can flow in several flow channels (16) arranged parallel to each other, wherein each flow channel (16) is assigned a UV-light output face (14) of the least one UV-light-generating body (12).

7. Device (10) according to claim 1, characterized in that the polluted water in the flow channels (16) flows sequentially past several UV-light output faces (14) of UV-light-generating bodies (12) arranged in the device (10).

8. Device (10) according to claim 1, characterized in that the at least one UV-light-generating body (12) is designed such that the water flowing by replaces an electrode for generating the UV radiation (18), in that the wafer flowing by can be electrically contacted.

9. Device (10) according to claim 8, characterized in that an electrode is coated with a reflective and conductive material.

10. Device (10) according to claim 8, characterized in that an inner side of the UV-light-generating body (12) is coated in sections with a reflective and conductive material.

11. Device (10) according to claim 1, characterized in that the UV-light-generating body (12) is designed to be flat, cubical, round, oval ring-shaped or ring-segment-shaped.

12. Device (10) according to claim 1, characterized in that the UV-light-generating body (12) has reinforcing supports in the interior.
